(19) United States
(12) Patent Application Publication
(10) Pub. No.: US 2020/0081211 A1
(43) Pub. Date: Mar. 12, 2020

(54) Fiber Optic Connection Box With Fluid Drainage Chute For Preventing Water Ingress

(71) Applicant: All Systems Broadband, Inc., Livermore, CA (US)

(72) Inventor: Craig Dwayne Ray, Raleigh, NC (US)

(21) Appl. No.: 16/493,597

(22) PCT Filed: May 3, 2017
(86) PCT No.: PCT/US2017/030751

§ 371 Date: Sep. 12, 2019

(51) Int. Cl. G02B 6/44

(52) U.S. Cl. CPC G02B 6/4444; G02B 6/445

(57) ABSTRACT

A connection box (100) for securing and storing a connection between service-provider-side fiber optic cabling includes a rear panel (102), outer walls (104) extending away from the rear panel (102) and forming an enclosed loop around a perimeter of the rear panel (102), and a flange (140) formed at a front side of the outer walls (104). The front side of the outer walls (104) is opposite from the rear panel (102). The connection box (100) further includes a channel (142) formed in the flange (140). The channel (142) is defined by inner and outer sidewall (144, 146) that face one another. The connection box (100) further includes a fluid drainage chute (148) formed in the flange (140), and an attachable front door (130). In a closed position of the connection box (100), the attachable front door (130) attaches to the flange (140) and encloses an interior volume of the connection box (100), and the fluid drainage chute (148) forms a conduit between the channel (142) and an exterior environment of the connection box (100).

### TECHNICAL FIELD

The present invention generally relates to optical communications equipment, and particularly relates to fiber demarcation boxes that are used for the storage of fiber optic cables.

### BACKGROUND

Today's communication networks provide transport of voice, video and data to both residential and commercial customers, with more and more of those customers being connected by fiber optic cables. In these communication networks, information is transmitted from one location to another by sending pulses of light through the fiber optic cables. Fiber optic transmission provides several advantages over electrical transmission techniques, such as increased bandwidth and lower losses.

Fiber optic connection boxes are used in fiber optic networks to store and secure a fiber optic connection and associated lengths of fiber optic cabling. These fiber optic connections include physical splices of optical fibers and standardized connection structures, such as SC connectors. Customer-side fiber optic cabling that comes from the customer's building is connected to service-provider network cabling that is external to the customer's building using these fiber optic connections. Both the customer-side fiber optic cabling and the service-provider cabling are routed into a connection box with some extra slack to allow for easy manipulation of the cabling. The connection is then effectuated and the excess lengths of fiber optic cabling are secured within the connection box. Optical circuitry (either passive or active) may also be connected to the cable and stored within the connection box.

One important design consideration for fiber optic connection boxes relates to the prevention of fluid ingress into the interior space of the connection box. When the fiber optic splice is complete and an installer closes the front door of the connection box, the connection box should ideally be sealed in such a way that it prevents foreign items, e.g., water, dust, particles, etc. from entering the interior space, as these foreign materials have the potential to damage the optical circuitry and associated fiber optic connections. For this reason, industry standard tests simulate heavy rain and wind conditions and measure whether a small amount of moisture can penetrate a fiber optic connection box.

Other important design considerations for fiber optic connection boxes include user friendliness and cost. Although elaborate sealing mechanisms may perform well at preventing fluid from entering the interior space of the fiber optic connection box, these sealing mechanisms add additional expense and/or require additional time by the installer when closing or opening the fiber optic connection box.

Thus, there is a need to provide a connection box that is used to secure and store a splice between service-provider cabling and customer-side fiber optic cabling that is inexpensive, user friendly, and highly resistant to water penetration during extreme weather conditions.

### SUMMARY

A connection box for securing and storing a connection between service-provider-side fiber optic cabling and customer-side fiber optic cabling is disclosed. According to an embodiment, the connection box includes a rear panel, outer walls extending away from the rear panel and forming an enclosed loop around a perimeter of the rear panel, and a flange formed at a front side of the outer walls. The front side of the outer walls is opposite from the rear panel. The connection box further includes a channel formed in the flange. The channel is defined by inner and outer sidewalls that face one another. The connection box further includes a fluid drainage chute formed in the flange, and an attachable front door. In a closed position of the connection box, the attachable front door attaches to the flange and encloses an interior volume of the connection box, and the fluid drainage chute forms a conduit between the channel and an exterior environment of the connection box.

According to another embodiment, the connection box includes a rear panel, outer walls extending away from the rear panel and forming an enclosed loop around a perimeter of the rear panel, and a flange formed at a front side of the outer walls. The front side of the outer walls is opposite from the rear panel. The connection box further includes an attachable front door that is configured to form a seal with the flange in a closed position of the connection box. The connection box further includes a first fluid drainage chute that forms a conduit between unsealed regions of the flange and an exterior environment of the connection box when the connection box is in the closed position.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 depicts, from an isometric perspective, a connection box with the front door being in an open position, according to an embodiment.

FIG. 2 depicts, from an isometric perspective, a connection box with the front door being in a closed position, according to an embodiment.

FIG. 3 depicts, from an isometric perspective, flange features of a connection box with the front door being in an open position, according to an embodiment.

FIG. 4 depicts, from a cross-sectional perspective, a collar of a front door being mated with the channel of a flange of a connection box when the front door is in the closed position, according to an embodiment.

FIG. 5 depicts, from an isometric perspective, a fluid drainage chute that is formed in a flange of a connection box, according to an embodiment.

### DETAILED DESCRIPTION

Embodiments of a fiber optic connection box described herein include advantageous and low-cost features that form a seal around the perimeter of the fiber optic connection box. This seal is impervious to the penetration of moisture in extreme weather conditions. The fiber optic connection box includes a rear enclosure, and an attachable front door. The rear enclosure includes a rear panel and outer walls formed around the perimeter of the rear panel. Front sides of the outer walls that are opposite the rear panel include a flange for affixing the front door to the rear enclosure. In an open position of the connection box, the interior volume of the rear enclosure is accessible to the installer. In a closed position of the connection box, the front door is affixed to the flange. Moreover, the flange and front door are configured to form a seal that prevents fluid (e.g., water) from entering the inside of the connection box when the door is closed. According to one embodiment, this seal is provided by a collar and channel system in which a raised collar on the front door interlocks with a channel formed in the flange.

Advantageously, the connection box may include one or more fluid drainage chutes that divert fluid (e.g., water) out of the channel region of the flange when the front door is closed. Although the above described collar and channel system is generally effective at preventing fluid from entering the interior volume of the connection box, in extreme weather conditions (e.g., heavy rain and wind) it is possible that some water can nonetheless penetrate the seal and enter the interior volume of the connection box. The fluid drainage chute mitigates this issue by providing a conduit between the channel and an exterior environment of the connection box. According to an embodiment, the fluid drainage chute includes a channel that gradually widens until it reaches an opening that is exposed to the exterior environment when the front door is shut. The fluid drainage chute is disposed at a location that allows the force of gravity to continuously drain fluid from the channel through the fluid drainage chute and out of the opening.

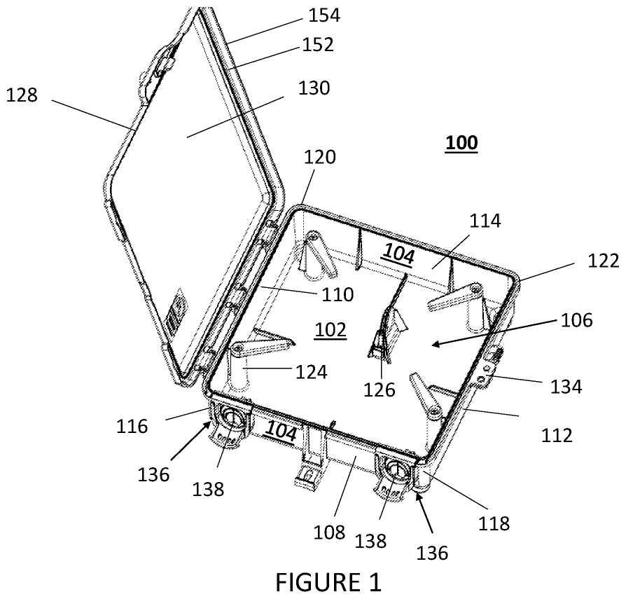

Referring to FIG. 1, a connection box 100 is depicted, according to an embodiment. The connection box 100 includes a rear panel 102. According to an embodiment, the rear panel 102 is generally planar. That is, the rear panel 102 extends substantially along a single plane. The connection box 100 further includes outer walls 104 that extend away from the rear panel 102. The outer walls 104 form an angled intersection with the rear panel 102. For example, the outer walls 104 may form a ninety-degree angle with the rear panel 102. Alternatively, the outer walls 104 may form an oblique angle with respect to the rear panel 102. The outer walls 104 form an enclosed loop around the perimeter of the rear panel 102. That is, the outer walls 104 extend completely around the perimeter of the rear panel 102 such that an interior space 106 of the connection box 100 is completely surrounded by the outer walls 104. In the depicted embodiment, the enclosed loop has a rectangular shape. As a result, the outer walls 104 include first, second, third and fourth planar sections 108, 110, 112, 114. The first, second, third and fourth planar sections 108, 110, 112, 114 that form first, second, third and fourth corners 116, 118, 120, 122 with one another. The first and second planar sections 108, 110 form a first corner 116, the first and third planar sections 108, 112 form a second corner 118, the fourth and second planar sections 114, 110 form a third corner 120, and the fourth and third planar 114, 112 sections form a fourth corner 122. More generally, any of a variety of geometries may be utilized as the basic shape of the connection box 100, and the outer walls 104 may have any number of planar sections and angled intersections forming these shapes.

The rear panel 102 and the outer walls 104 collectively provide a rear enclosure that provides an interior volume, i.e., a three-dimensional space, for the securing and storage of fiber optical cabling and hardware. In the depicted embodiment, the interior volume includes a number of posts 124 for the spooling of fiber optic cabling and a retention feature 126 for the securing of a fiber optic hardware, such as a splice tray. These features represent just a few examples of the interior features that can be provided in the connection box 100. More generally, the connection box 100 may include a variety of features formed on or affixed to the rear panel 102 and/or to the outer walls 104 that can be used for fiber optic terminations.

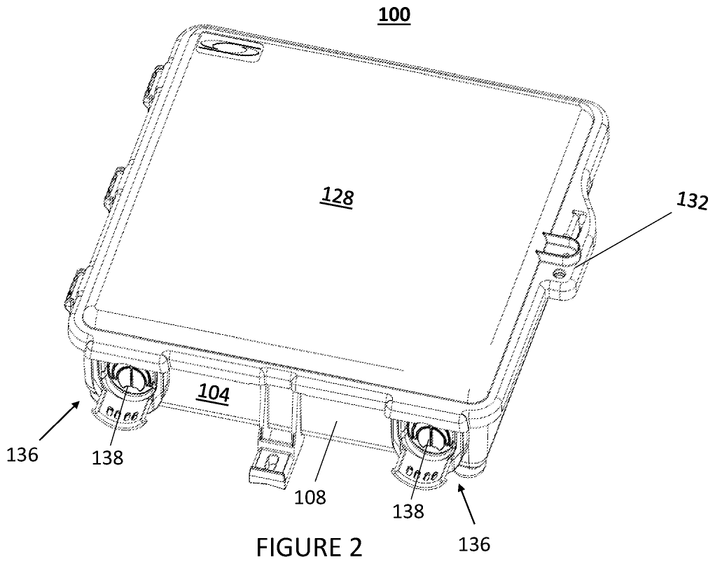

The connection box 100 further includes an attachable front door 128. The attachable front door 128 is configured to completely enclose the interior volume of the rear enclosure. That is, the attachable front door 128 is at least as large as the enclosed loop and can be placed over the outer walls 104 so as to completely contact the outer walls 104. In the depicted embodiment, the attachable front door 128 is affixed to the outer walls 104 of the connection box 100 by hinges. In this way, the attachable front door 128 can be moved between an open position as depicted in FIG. 1 and a closed position as depicted in FIG. 2. Alternatively, the attachable front door 128 may be completely detached from the outer walls 104 in the open position. That is, the hinged connection is optional.

Referring to FIG. 2, the connection box 100 is depicted with the attachable front door 128 in a closed or shut position. In this position, the rear panel 102, the outer walls 104, and a front surface 130 of the attachable front door 128 (as shown in FIG. 1) enclose an interior volume within the connection box 100. Thus, in the closed position, the connection box 100 houses and protects any items, e.g., fiber optical cabling and hardware that is contained within the interior volume. Optionally, the attachable front door 128 may include a locking feature 132 that mates with a corresponding locking feature 134 (as shown in FIG. 1) that extends away from the outer walls 104. These locking features 132, 134 can accommodate a locking mechanism, e.g., padlock, chain, etc., so as to maintain the attachable front door 128 in the closed position and to prevent unauthorized entry into the connection box 100.

According to an embodiment, the connection box 100 includes a cable port 136 formed in one of the outer walls 104. For example, as shown in FIGS. 1-2, the connection box 100 includes two cable ports 136 that are formed in the first planar section 108 of the outer walls 104. The cable ports 136 provide access to the interior space 106 for the routing of fiber optic cabling into the interior space 106 without opening the attachable front door 128. Optionally, a fitting 138 may be inserted in these cable ports 136. This fitting 138 allows fiber optic cabling to be routed through it while also providing a seal that prevents moisture, dust, particles, etc. from entering the connection box 100. An exemplary rubber grommet that is suitable for this purpose is described in U.S. Pat. No. 9,251,786 to Ray, the content of which is incorporated by reference herein in its entirety.

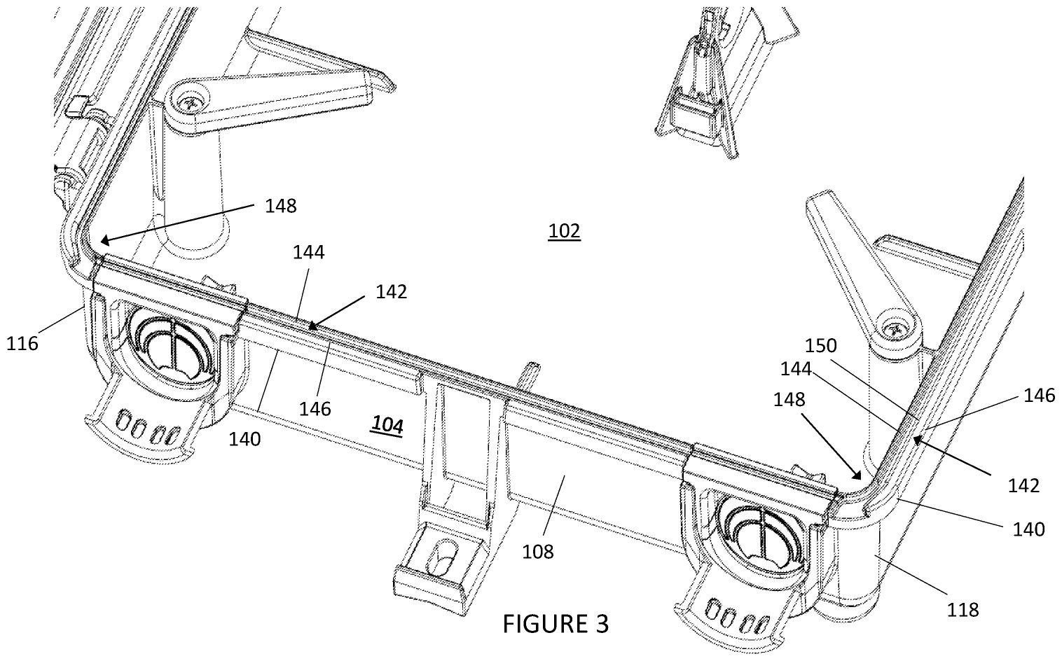

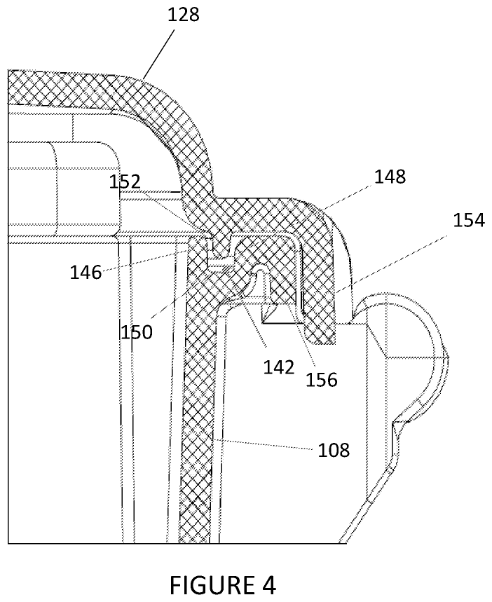

The attachable front door 128 is configured form a seal with the outer walls 104 in a closed position of the connection box 100. This seal prevents any material, e.g., particles, dust, moisture, etc. from entering the enclosed interior volume and potentially damaging any items, e.g., fiber optical cabling and hardware that is contained within the interior volume, while the attachable front door 128 is in the closed position. An exemplary channel and collar system for forming this seal is shown in FIGS. 3-4.

Referring to FIG. 3, the connection box 100 further includes a flange 140 at a front side of the outer walls 104 that is opposite the rear panel 102. The flange 140 forms a rim in the outer walls 104 that is designed to engage with and interface with the attachable front door 128 when the attachable front door 128 contacts the flange 140. As seen in the depicted embodiment, the flange 140 may project outward from the outer walls 104 in a direction that is substantially perpendicular to the outer walls 104 and/or substantially parallel to the rear panel 102.

The flange 140 includes a channel 142 that is defined by inner and outer sidewalls 144, 146. These inner and outer sidewalls 144, 146 face one another. The inner sidewalls 144 are disposed inside of the outer sidewalls 146. The inner and outer sidewalls 144, 146 extend along the flange 140 in the shape of the enclosed loop. That is, the inner and outer sidewalls 144, 146 are formed around the perimeter of the connection box 100. This channel 142 may completely extend around the perimeter of the connection box 100, with the exception of the locations of the cable ports 136 and the fluid drainage chutes 148, which will be described in further detail below.

According to an embodiment, the channel 142 is further defined by a lower surface 150 that extends between the inner and outer sidewalls 144, 146 and provides a bottom of the channel 142. The lower surface 150 may be a planar surface that forms an angled intersection with the inner and outer sidewalls 144, 146. For example, according to one embodiment, the inner and outer sidewalls 144, 146 form a substantially perpendicular angle with the lower surface 150. Alternatively, the lower surface 150 may form an oblique angle with the inner and outer sidewalls 144, 146. According to yet another embodiment, the lower surface 150 may be a curved surface. That is, the channel 142 has a U-shape in this embodiment. According to yet another embodiment, the inner and outer sidewalls 144, 146 directly adjoin one other in a V-shape.

Referring again to FIG. 1, the attachable front door 128 includes a collar 152 disposed on the front surface 130 of the attachable front door 128. The collar 152 is a thin, projecting feature that protrudes away from the front surface 130 of the attachable front door 128. The collar 152 is configured to be mated with the channel 142. According to an embodiment, the collar 152 has the same shape as the enclosed loop. For example, in the depicted embodiment, the enclosed loop of the outer walls 104 forms a rectangle, and the collar 152 also forms a rectangle. The size of these two rectangles can be closely correlated to one another. The attachable front door 128 may additionally include an outer hood 154 that is formed around an outer perimeter of the attachable front door 128. The outer hood 154 extends away from the plane of the attachable front door 128 in the same direction as the collar 152.

Referring to FIG. 4, a close up cross-sectional view illustrates the collar 152 being inserted in the channel 142. This view corresponds to the closed position of the connection box 100. As can be seen, when the attachable front door 128 is closed, the collar 152 extends into the channel 142. In this regard, the cross-sectional geometry of the collar 152 can be correlated to the cross-sectional geometry of the channel 142. That is, the height and width of the collar 152 is determined by the width and depth of the channel 142, which is defined by the inner and outer sidewalls 146, 148 and the lower surface 150 (if present). In the depicted embodiment, the collar 152 is dimensioned for a loose fit in the channel 142. Alternatively, the collar 152 may be configured to interlock with the channel 142. That is, the dimensioning and shapes of the channel 142 and collar 152 may be corresponded to one another such that the collar 152 and channel 142 directly contact one another and provide some degree of physical resistance when the attachable front door 128 is moved from the open position to the closed position or vice-versa.

The outer hood 154 overhangs past an outer side of the flange 140. This outer side of the flange 140 includes an overhanging portion 156 that is spaced apart from and parallel to the outer walls 104. The outer hood 154 is dimensioned to extend over the overhanging portion 156 with minimal clearance between the two.

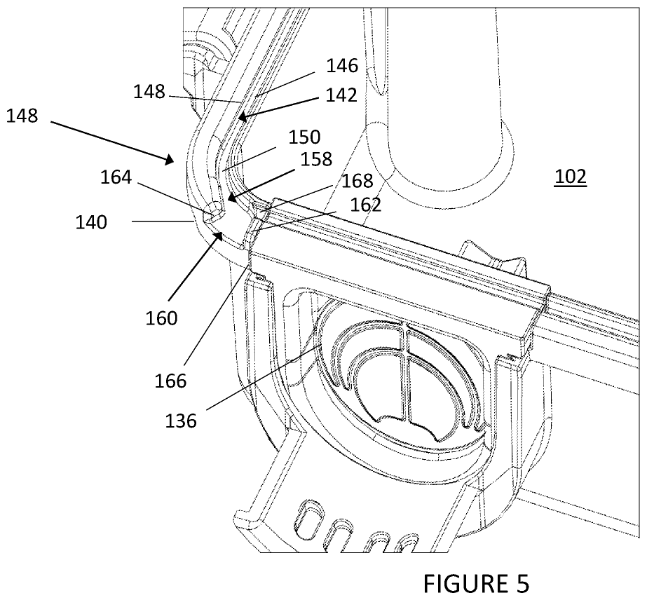

The combination of the features shown in FIG. 5 provide a seal around the perimeter of the connection box 100. This seal is highly impermeable to the penetration of foreign material, e.g., water, dust, particles, etc., into the enclosed interior volume of the connection box 100. The combination of the outer hood 154 and the overhanging portion 156 of the flange 140 provide a first level barrier that blocks most foreign material from entering the channel 142 at all. Moreover, the collar 152 and the channel 142 provide a second level barrier that mostly blocks any foreign material does enter the channel 142 from further penetrating the connection box 100. Nonetheless, this system is not entirely effective at prohibiting foreign material from penetrating the interior volume. For example, under extreme rain and wind conditions, a non-negligible amount of water can penetrate past the outer hood 154 and the overhanging portion 156. This water accumulates in the channel 142 and, over time, exerts upward pressure on the attachable front door 128. With sufficient upward pressure, some of this water can spill over the inner sidewall of the flange 140 and enter the enclosed interior volume of the connection box 100.

Referring to FIG. 5, the connection box 100 further includes a fluid drainage chute 148 that prevents the above described penetration of water into the enclosed interior volume. The fluid drainage chute 148 provides a conduit between the channel 142 and an exterior environment of the connection box 100, i.e., the ambient air that is outside of connection box 100, when the attachable front door 130 is in the closed position. The conduit forms a direct path for fluid that accumulates in unsealed regions of the flange 140, e.g., a region of the channel 142 that is beneath the collar 152, and the exterior environment, when the front door 130 is in the closed position. Thus, the fluid drainage chute 148 provides a pathway for any water that accumulates in the channel 142 beneath the collar 152 to exit the channel 142 without penetrating the seal.

The fluid drainage chute 148 includes a channel portion 158 and an opening 160 in the flange 140 that exposes the channel 142 to the exterior environment. The channel portion 158 of the fluid drainage chute 148 may be provided by a widened portion of the channel 142 that is formed in flange 140. For example, in the depicted embodiment, outside of the fluid drainage chute 148, the inner and outer sidewalls 144, 146 of the channel 142 that are separated from one another by a fixed distance. As explained with reference to FIG. 4, this distance is correlated to the width of the collar 152 on the attachable front door 128. Moreover, outside of the fluid drainage chute 148, the inner and outer sidewalls 144, 146 of the channel 142 run parallel to one another. Once these parallel inner and outer sidewalls 144, 146 reach the fluid drainage chute 148, the channel 142 widens. That is, the inner and outer sidewalls 144, 146 of the channel 142 extend away from one another as they extend towards the opening 160 in the flange 140. According to one embodiment, the width of the channel 142 in the fluid drainage chute 148 gradually increases until it reaches the opening 160 in the flange 140. More generally, the channel portion 158 of the fluid drainage chute 148 can have any geometry that is conducive to guiding fluid towards the opening 160 in the flange 140.

In the embodiments in which the channel 142 of the flange 140 includes a planar lower surface 150, the widening of the channel 142 may be defined in terms of a base width of the channel 142, which is a width of the lower surface 150 of the channel 142. That is, the base width of the channel 142 refers to the distance between the angled intersection of the outer sidewall 148 and the lower surface 150 and the angled intersection of the inner sidewall 146 and the lower surface 150. In the fluid drainage chute 148, this base width is greater than in the regions of the channel 142 that are outside of the fluid drainage chute 148. In embodiments in which the channel 142 does not include a planar lower surface 150, the width of the channel 142 can be measured between any coplanar locations on the inner and outer sidewalls 144, 146.

According to an embodiment, the opening 160 in the flange 140 is provided by a void in the outer sidewall 148 of the channel 142. This void corresponds to a portion of the flange 140 in which the outer sidewall 148 does not exist. In this region, a lowermost surface of the channel 142 (e.g., the lower planar surface of the channel 142 in the depicted example) extends completely to an outer edge of the flange 140. This void in the outer sidewall 148 provides an opening 160 that exposes unsealed regions of the channel 142, i.e., the volume that is disposed beneath the collar 152, to the exterior environment. Instead of a void in the outer sidewall 148, the opening 160 can be provided by other features. For example, one or more perforations can be provided in the outer sidewall 148 and/or the lower surface 150 of the channel 142 to expose the channel 142 the exterior environment when the front door 130 is in the closed position.

According to an embodiment, the channel portion 158 of the fluid drainage chute 148 is directly adjacent to a cable port 136 of the connection box 100. In the embodiment of FIG. 5, the channel portion 158 of the fluid drainage chute 148 includes a first section 162 of the inner sidewall 146 that is directly adjacent to the recess 166 of the cable port 136. A first section 164 of the outer sidewall 148 is spaced apart from the first section 162 of the inner sidewall 146. The first section 162 of the inner sidewall 146 and the first section 164 of the outer sidewall 148 extend away from one another as they approach the outer edge of the flange 140. The void in the outer sidewall 148 of the channel 142 extends between the first section 162 of the inner sidewall 146 and the first section 164 of the outer sidewall 148 at the outer edge of the flange 140.

The first section 162 of the inner sidewall 146 that is directly adjacent to the recess 166 of the cable port 136 forms a barrier that separates a lower surface 150 of the channel 142 from the recess 166 of the cable port 136. This barrier prevents water that is flowing through the channel 142 from entering the cable port 136. Even if a fixture 136, such as a grommet, is provided in the cable port 136 as depicted, this fixture 136 may not completely effective at preventing water from entering the enclosed interior volume. Thus, the first section 162 of the inner sidewall 146 provides an additional barrier that ensures that fluid flowing through the fluid drainage chute 148 will not enter the enclosed interior volume.

According to an embodiment, a ridge 168 is formed on an upper surface of the first section 162 of the inner sidewall 146. The ridge 168 may be dimensioned with a corresponding shape as the collar 152. That is, a width and depth of the ridge 168 may be substantially close to or identical to a height and width of the collar 152. This ridge 168 interlocks with the collar 152 when the attachable front door 128 is in the closed position. In this way, the seal that is provided by the collar 152 can be provided around the complete perimeter of the connection box 100.

Referring again to FIG. 3, the connection box 100 may include more than one of the fluid drainage chutes 148. These fluid drainage chutes 148 may be provided at locations that are well suited for the removal of fluid from the channel 142 to the exterior environment. For instance, in the embodiment of FIG. 3, the connection box 100 includes a first fluid drainage chute 148 that is disposed at the first corner 116 of the outer walls 104 and a second fluid drainage chute 148 that is disposed at the second corner 118 of the outer walls 104. When the connection box 100 is mounted against another object, e.g., an exterior wall of a customer building, the first and second corners 116, 118 are disposed on a bottom side of the connection box 100 beneath the third and fourth corners 120, 122. In this arrangement, gravity will cause fluid to naturally flow down the channels 142 of the second and third outer walls 104. The first and second fluid drainage chutes 148 provide an outlet at the bottom of these channels 142 that permits this water to exit. In this way, fluid that accrues in the channel 142 over time is continuously removed from the flange 140 by the force of gravity. Moreover, each of the first and second fluid drainage chutes 148 may include the first section 162 of the inner sidewall 146 that is directly adjacent to the recess of an adjacent cable port 136. In this way, fluid that is flowing through the channel 142 is prevented from entering the first and second cable ports 136 in the above described manner

More generally, the connection box 100 can include any number of the fluid drainage chutes 148, e.g., three, four, five, etc. Moreover, the locations of these fluid drainage chutes 148 may vary depending on, among other things, the basic geometry of the connection box 100. In general, the fluid drainage chutes 148 may be provided at any location that is a natural gathering point of accumulated water when the connection box 100 is mounted against a wall and subjected to high rain conditions.

Spatially relative terms such as “under,” “below,” “lower,” “over,” “upper” and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having,” “containing,” “including,” “comprising” and the like are open-ended terms that indicate the presence of stated elements or features, but do not preclude additional elements or features. The articles “a,” “an” and “the” are intended to include the plural as well as the singular, unless the context clearly indicates otherwise.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-17. (canceled)

18. A connection box for securing and storing a connection between service-provider-side fiber optic cabling and customer-side fiber optic cabling, the connection box comprising:
a rear panel;
outer walls extending away from the rear panel and forming an enclosed loop around a perimeter of the rear panel;
a flange formed at a front side of the outer walls, the front side of the outer walls being opposite from the rear panel,
a channel formed in the flange, the channel being defined by inner and outer sidewalls that face one another;
a fluid drainage chute formed in the flange; and
an attachable front door;
wherein in a closed position of the connection box:
the attachable front door attaches to the flange and encloses an interior volume of the connection box; and
the fluid drainage chute forms a conduit between the channel and an exterior environment of the connection box,
wherein the enclosed loop comprises first and second planar sections that form an angled intersection with one another, and
wherein the fluid drainage chute is disposed directly at the angled intersection.

19. The connection box of claim 18, wherein the conduit between the channel and an exterior environment of the connection box comprises a widened portion of the channel and an opening in the flange that is exposed to the exterior environment in the closed position of the connection box.

20. The connection box of claim 19, wherein the opening in the flange comprises is disposed in the outer sidewall.

21. The connection box of claim 20, further comprising a cable port in the outer walls, the cable port forming a recess that extends from the flange towards the rear panel, wherein a first section of the inner sidewall in the fluid drainage chute forms a barrier separating a lower surface of the channel from the recess.

22. The connection box of claim 21, wherein the first section of the inner sidewall comprises a ridge, and wherein a collar formed in the attachable front door interlocks with the ridge in the closed position of the connection box.

23. The connection box of claim 21, wherein the fluid drainage chute comprises the first section of the inner sidewall and a first section of the outer sidewall, wherein the first section of the inner sidewall and the first section of the outer sidewall each extend to an outer edge of the flange, and wherein the opening extends between the first section of the inner sidewall and the first section of the outer sidewall at the outer edge of the flange.

24. The connection box of claim 20, wherein the inner and outer sidewall of the channel extend parallel to one another along the flange outside of the fluid drainage chute, and wherein the inner and outer sidewall of the channel extend away from one another in the fluid drainage chute such that a width of the channel increases until it reaches the opening.

25. The connection box of claim 18, wherein the enclosed loop further comprises third and fourth planar sections, wherein the first, second, third and fourth planar sections have a rectangular shape, and wherein the angled intersection is disposed at a first corner between the first and second planar sections.

26. The connection box of claim 25, wherein the first planar section of the outer walls extends between the first corner and a second corner between the first and third planar sections, wherein the connection box comprises two of the fluid drainage chutes, wherein a first one of the fluid drainage chutes is disposed at the first corner of the outer walls, and wherein a second one of the fluid drainage chutes is disposed at the second corner of the outer walls.

27. The connection box of claim 26, wherein the connection box further comprises first and second cable ports in the first planar section of the outer walls, each of the first and second cable ports forming a recess that extends from the flange towards the rear panel, wherein the first fluid drainage chute directly adjoins the first cable port and wherein the second fluid drainage chute directly adjoins the second cable port.

28. A connection box for securing and storing a connection between service-provider-side fiber optic cabling and customer-side fiber optic cabling, the connection box comprising:
a rear panel;
outer walls extending away from the rear panel and forming an enclosed loop around a perimeter of the rear panel;
a flange formed at a front side of the outer walls, the front side of the outer walls being opposite from the rear panel;
an attachable front door that is configured to form a seal with the flange in a closed position of the connection box;
a first fluid drainage chute that forms a conduit between unsealed regions of the flange and an exterior environment of the connection box when the connection box is in the closed position,
wherein the first fluid drainage chute comprises a channel and an opening in the flange that exposes the channel to the exterior environment of the connection box,
wherein the channel widens as it approaches the opening in the flange.

29. The connection box of claim 28, wherein the enclosed loop has a rectangular shape such that the outer walls comprise first, second, third and fourth planar sections that form first, second, third and fourth corners with one another, and wherein the first fluid drainage chute is disposed at the first corner.

30. The connection box of claim 29, wherein the connection box further comprises a first cable port in the first planar section of the outer walls, the first planar section extending from the first corner to a second corner, the first cable port comprising a recess that extends from the flange towards the rear panel, and wherein the first fluid drainage chute comprises a barrier that isolates the channel from the recess of the first cable port.

31. The connection box of claim 30, wherein the barrier that isolates the channel from the recess of the first cable port comprises a ridge, and wherein the attachable front door forms the seal with the ridge when the connection box is in the closed position.

32. The connection box of claim 30, wherein the connection box further comprises a second cable port in the first planar section of the outer walls and a second fluid drainage chute disposed at the second corner, the second cable port comprising a recess that extends from the flange towards the rear panel, and wherein the second fluid drainage chute comprises a barrier that isolates the channel from the recess of the second cable port.

33. A connection box for securing and storing a connection between service-provider-side fiber optic cabling and customer-side fiber optic cabling, the connection box comprising:
a rear panel;
outer walls extending away from the rear panel and forming an enclosed loop around a perimeter of the rear panel;
a flange formed at a front side of the outer walls, the front side of the outer walls being opposite from the rear panel, a channel formed in the flange, the channel being defined by inner and outer sidewalls that face one another;
a fluid drainage chute formed in the flange; and
an attachable front door;
wherein in a closed position of the connection box:
the attachable front door attaches to the flange and encloses an interior volume of the connection box; and
the fluid drainage chute forms a conduit between the channel and an exterior environment of the connection box.
